(19) United States
(12) Patent Application Publication
(10) Pub. No.: US 2026/0229244 A1
(43) Pub. Date: Aug. 6, 2026

(54) Adaptive Playback of Media Content

(71) Applicant: Apple Inc., Cupertino, CA (US)

(72) Inventors: Aaron Hodges, San Jose, CA (US); Ismael H. Nawfal, Redondo Beach, CA (US); Matthew E. Leon, San Francisco, CA (US)

(21) Appl. No.: 19/392,869

(22) Filed: Nov. 18, 2025

Related U.S. Application Data
(60) Provisional application No. 63/753,717, filed on Feb. 4, 2025.

(51) Int. Cl. G10L 21/0364; G10L 25/93

(52) U.S. Cl. CPC G10L 21/0364; G10L 25/93

(57) ABSTRACT

A system for adaptive playback of media content may include a speaker to play media content including a speech portion and a non-speech portion, a microphone to pick up a sound field in an environment of a user, and a processor configured to: receive i) a speech audio signal including the speech portion, and ii) a reference audio signal including the non-speech portion; receive an ambient signal from the microphone based on the sound field; and adjust amounts of the speech audio signal and the reference audio signal based on the ambient signal to produce an adaptive playback signal to drive the speaker. Other aspects are also described and claimed.

### RELATED APPLICATIONS

This application claims the benefit of priority of U.S. Provisional Application No. 63/753,717, filed February 4, 2025, which is herein incorporated by reference.

### BACKGROUND

### FIELD

This disclosure relates generally to audio adjustments for playback of media content and, more specifically, to adaptive playback of media content based on an ambient signal. Other aspects are also described.

### BACKGROUND INFORMATION

Headphones (or earphones) enable a user to listen to media content, such as music, podcasts, and movie soundtracks, without disturbing others who are nearby. Different headphone types may include over-ear, on-ear, loose fitting earbud, and sealing in-ear. Headphones may have varying amounts of passive sound isolation against ambient noise, depending on their materials and how closely they fit a user’s head or ear. In many instances, there may be some leakage of ambient noise into the ear that can be heard by the user.

A technique known as adaptive noise cancellation or active noise control, ANC, can be used to drive a speaker of the headphone to generate a sound field that is electronically designed to destructively interfere with the leaked ambient sound to generate a quiet region at the user’s ear drum. The ANC mode may be useful in situations in which the user desires an immersive experience with the headphones. Another technique known as (active) transparency can be used to drive the speaker of the headphone to reproduce the ambient sound at the user’s ear drum. The transparency mode may be useful in situations where the passive sound isolation is particularly strong yet the user prefers to hear their ambient environment (without having to remove the headphones.)

### SUMMARY

Implementations of this disclosure include selectively mixing an audio signal from media content, referred to as a reference audio signal, with an enhanced audio signal of the media content, referred to as a speech audio signal, based on a sound field picked up in an environment of a user. In some cases, the reference audio signal may be a background audio signal that includes only a non-speech portion of the media content, such as music, sound effects, or other non-speech. In some cases, the reference audio signal may be an original audio signal that includes both a speech portion and a non-speech portion of the media content. The speech audio signal may be a speech-only audio signal that includes only a speech portion of the media content, such as a dialogue, vocal or other speech.

A microphone of a device can pick up the sound field and produce an ambient signal representing the sound field. An amount of the speech audio signal may then be mixed with another amount of the reference audio signal, and adjusted based on the ambient signal, to produce an adaptive playback signal to drive one or more speakers of the device. In some cases, the amounts may be mixed and adjusted continuously based on spectral differences between the ambient signal (and its speech band frequency content) and the speech portion of the media content. In some cases, the amounts may be mixed and adjusted based on input from the user, such as a personal volume set by the user. The amounts may each have a gain applied, including to maintain the personal volume. As a result, a user can listen to media content in different environments with greater intelligibility while maintaining their personal volume.

Some implementations may include a system for adaptive playback of media content, including: a speaker to play media content including a speech portion and a non-speech portion; a microphone to pick up a sound field in an environment of a user; and a processor configured to: receive i) a speech audio signal including the speech portion, and ii) a reference audio signal including the non-speech portion; receive an ambient signal from the microphone based on the sound field; and adjust amounts of the speech audio signal and the reference audio signal based on the ambient signal to produce an adaptive playback signal to drive the speaker.

Some implementations may include a method for adaptive playback of media content, including: receiving media content including i) a speech audio signal including a speech portion, and ii) a reference audio signal including a non-speech portion; receiving an ambient signal from a microphone based on a sound field in an environment of a user picked up by the microphone; and adjusting amounts of the speech audio signal and the reference audio signal based on the ambient signal to produce an adaptive playback signal to drive a speaker to play the media content. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is a first example of a system for adaptive playback of media content.

FIG. 2 is a second example of a system for adaptive playback of media content.

FIG. 3 is an example of a first sound field picked up by a microphone.

FIG. 4 is an example of a first curve for adjusting a speech audio signal.

FIG. 5 is an example of a first curve for adjusting a reference audio signal.

FIG. 6 is an example of a second sound field picked up by a microphone.

FIG. 7 is an example of a second curve for adjusting a speech audio signal.

FIG. 8 is an example of a second curve for adjusting a reference audio signal.

FIG. 9 is an example of mixing amounts of a speech audio signal and a reference audio signal at a first time to produce an adaptive playback signal.

FIG. 10 is an example of mixing amounts of a speech audio signal and a reference audio signal at a second time to produce an adaptive playback signal.

FIG. 11 is an example of a process for adaptive playback of media content

FIG. 12 is an example of hardware which may be used for adaptive playback of media content.

### DETAILED DESCRIPTION

Some devices, such as wearable devices or headphones, may have speakers that are less capable than larger speakers of other devices. For example, sound quality from speakers of certain devices may be limited by the small physical size of the speakers, the power available, the distance between speakers for producing stereo output, sound wave reflections caused by the small size, etc. These limitations may affect the intelligibility of speech portions of the content, such as dialogue of a movie, vocals of music, etc., particularly when the environment where the user is playing the media content is loud.

For example, if a user is in a quiet environment such as an empty room, the user might better understand speech portions of the media content. However, if the user is in a loud environment such as an airport or café with many people talking, the user might struggle to understand the speech portions. Moreover, the user may desire to maintain a personal volume of the media content. A personal volume refers to a volume of media content that adjusts in response to changes in the environment, e.g., getting louder or quieter with the environment. It is therefore desirable to improve the intelligibility of media content in different environments while maintaining a personal volume set by the user.

Implementations of this disclosure address problems such as these by selectively mixing an audio signal from media content, referred to as a reference audio signal, with an enhanced audio signal of the media content, referred to as a speech audio signal (e.g., voice isolation), based on a sound field picked up in an environment of a user. In some cases, the reference audio signal may be a background audio signal that includes only a non-speech portion of the media content, such as music, sound effects, or other non-speech. In some cases, the reference audio signal may be an original audio signal that includes both a speech portion and a non-speech portion of the media content. The speech audio signal may be a speech-only audio signal that includes only a speech portion of the media content, such as a dialogue, vocal or other speech.

A microphone of a device can pick up the sound field and produce an ambient signal representing the sound field. An amount of the speech audio signal may then be mixed with another amount of the reference audio signal, and adjusted based on the ambient signal, to produce an adaptive playback signal to drive one or more speakers of the device. In some cases, the amounts may be mixed and adjusted continuously based on spectral differences between the ambient signal (and its speech band frequency content) and the speech portion of the media content. In some cases, the amounts may be mixed and adjusted based on input from the user, such as a personal volume set by the user. The amounts may each have a gain applied, including to maintain the personal volume. As a result, a user can listen to media content in different environments with greater intelligibility while maintaining their personal volume.

In some implementations, a system such as a wearable device may utilize two audio streams or signals, such as the reference audio signal (e.g., original media content) and the speech audio signal (e.g., an alternative audio stream that includes enhanced dialogue). The system may determine frequency masking in the environment by sampling (acoustically) frequency responses and comparing that with the media content being played back to determine parts that are masked in the environment. The system can then determine how to mix the two signals so that speech/intelligibility is enhanced (and personal volume maintained).

For example, when located in a quiet environment such as an empty room, the system may detect less frequency energy and/or less speech masking. As a result, the system can adjust amounts of the speech audio signal and/or the reference audio signal so that the signals are mixed equally. However, when located in a loud environment such as an airport or café with many people talking, the system may detect more frequency energy and more speech masking (e.g., low or high frequency speech bands). As a result, the system can adjust amounts of the speech audio signal and/or the reference audio signal so that the speech audio signal is emphasized and the reference audio signal is de-emphasized. To maintain the personal volume, as the environment gets louder, the speech audio signal and/or the reference audio signal may have a gain applied, which gain may correspond to a previously determined mix of the signals.

While the amounts of the speech audio signal and the reference audio signal may be determined based on the ambient signal, in some cases, the amounts may be determined based on user input. For example, the user input may include the personal volume (e.g., a listening level, such as a user preference to listen to the media content at 60% volume) and/or an indication to limit volume level exposure (e.g., to control an amount of noise the user may be exposed to over time, such as below a certain dBA, as in a dosimeter).

Further, in some implementations, a power optimization algorithm may be utilized to constrain filters applied to the signals. For example, when a limited amount of power is available (e.g., a low power mode of a wearable device), the system can amplify the speech audio signal and eliminate the reference audio signal entirely.

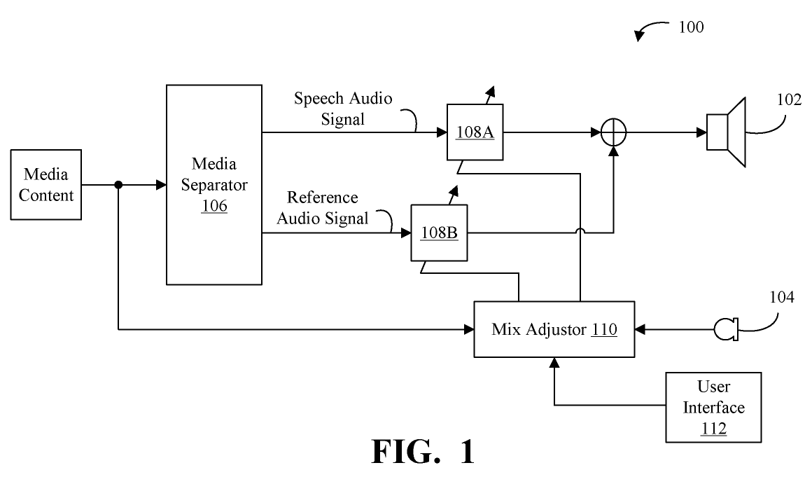

FIG. 1 is an example of a system 100 for adaptive playback of media content. The system 100 may be implemented by an electronic device utilized by a user, such as wearable device (e.g., headphones worn by a user). The system 100 may include a speaker 102, a microphone 104, a communications device, data storage, and/or a processor configured to execute instructions stored in memory. The communications device can receive media content (e.g., streaming) which may be stored via the data storage. The media content may include, for example, music, podcasts, movie soundtracks, etc. The media content may include a speech portion, such as a dialogue or vocal, and a non-speech portion, such as music or sound effects. The speaker 102 can receive a playback signal to play the media content for the user of the device. The playback signal may be an adaptive playback signal as described herein. Further, the microphone 104 can pick up a sound field in an environment of the user. The microphone 104 can produce an ambient signal representing acoustic sampling of frequency responses in the sound field. In some cases, the system 100 may utilize beamforming via a plurality of microphones to pick up a sound field in a select portion of the environment to produce the ambient signal.

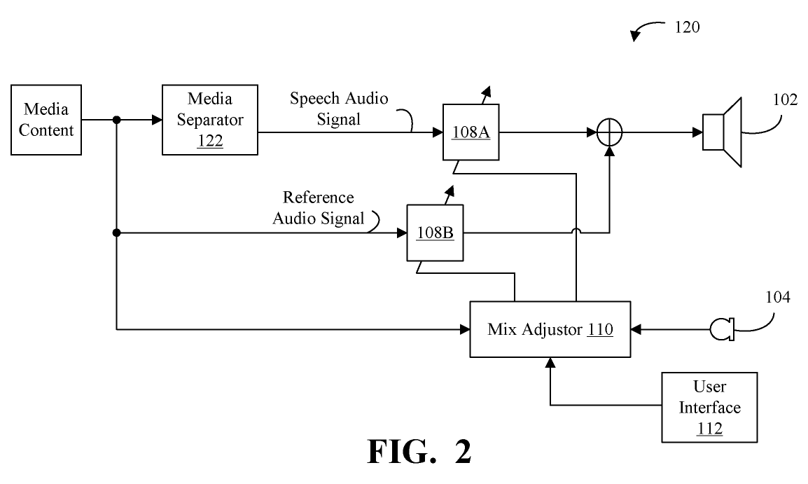

The system 100 may also include a media separator 106, a first digital signal processing component 108A, a second digital signal processing component 108B, a mix adjustor 110, and/or a user interface 112. These structures may be implemented in hardware, software, and/or a combination of both. The media separator 106 can receive media content (e.g., from the communications device and/or the data storage) and separate the media content into a speech audio signal and a reference audio signal. The speech audio signal may be a speech-only audio signal that includes only a speech portion of the media content, such as a dialogue or vocal. The reference audio signal may be a background audio signal that includes only the non-speech portion of the media content, such as music or sound effects. In some cases, the reference audio signal may be purely a background audio signal as shown in FIG. 1 (e.g., the reference audio signal might not include the speech portion) . In other cases, the reference audio signal may include both the speech portion and the non-speech portion of the media content as shown in FIG. 2 (e.g., the reference audio signal may be an original audio signal from the media content).

In some implementations, the media separator 106 can utilize a machine learning model to separate the media content into the speech audio signal and the reference audio signal. The machine learning model can detect features of the original audio signal from the media content to produce the speech audio signal and/or the reference audio signal. For example, the media separator 106 can utilize a transformer based neural network, such as a CNN and/or a transformer encoder, to produce the speech audio signal and/or the reference audio signal. In other examples, the media separator 106 can include neural networks such as an Artificial Neural Network (ANN), Recurrent Neural Network (RNN), Adversarial Network (GAN), Reinforcement Learning Model (RLM), Encoder/Decoder Networks, and/or Transformer-Based Models (e.g., Bidirectional Encoder Representations from Transformers (BERT), Generative Pre-trained Transformer (GPT), and/or a multi-modal large language model (LLM)). Additionally or alternatively, the media separator 106 can be or include any non-learning processes such as rule-based systems, heuristics, decision trees, knowledge-based systems, statistical or stochastic systems, and expert systems.

The media separator 106 can extract the speech audio signal from the media content (e.g., enhanced speech). The media separator 106 can also extract the reference audio signal from the media content (e.g., background). The mix adjustor 110 can then determine amounts of the speech audio signal, via the first digital signal processing component 108A, and the reference audio signal, via the second digital signal processing component 108B, based on the ambient signal and/or the user input, to mix and adjust the amounts to produce the adaptive playback signal. While the first digital signal processing component 108A, the second digital signal processing component 108B, and the mix adjustor 110 are shown as separate components, their functionality may be combined.

For example, the first digital signal processing component 108A may receive the speech audio signal, and the second digital signal processing component 108B may receive the reference audio signal, from the media separator 106. The first digital signal processing component 108A and the second digital signal processing component 108B may be dynamically controlled by the mix adjustor 110. The mix adjustor 110 may receive the ambient signal from the microphone 104 based on the sound field in the environment. For example, the sound field may indicate a quiet environment such as an empty room where the user might better understand the speech portions of the media content, or a loud environment such as an airport or café with many people talking where the user might struggle to understand the speech portions of the media content. The mix adjustor 110 may mix/adjust the amounts via the digital signal processing components based on this environmental detection. In some cases, the mix adjustor 110 may also receive user input via the user interface 112. For example, the user input may indicate a personal volume set by the user to be maintained. The mix adjustor 110 may apply gains to the signals via the digital signal processing components based on the determined sound field from the ambient signal and the system volume from the user input.

In particular, the mix adjustor 110 can adjust amounts of the speech audio signal, via the first digital signal processing component 108A, and the reference audio signal, via the second digital signal processing component 108B, based on the ambient signal and/or the user input, to produce the adaptive playback signal to drive the speaker 102. The adaptive playback signal may be produced by mixing a first amount of the speech audio signal with a second amount of the reference audio signal. The mix adjustor 110 can selectively control the first amount via the first digital signal processing component 108A and the second amount via the second digital signal processing component 108B. Including more of the speech audio signal via the first digital signal processing component 108A may increase intelligibility of the speech portion in the adaptive playback signal, and including more of the reference audio signal via the second digital signal processing component 108B may maintain a loudness of the media content. To control the amounts, the mix adjustor 110 can determine frequency masking in the environment by acoustically sampling frequency responses via the ambient signal and comparing those responses with the media content being played to determine parts that are masked. The system can then determine how to mix the speech audio signal and the reference audio signal so that speech is enhanced and personal volume is maintained. As a result, the system 100 can selectively mix the reference audio signal with the speech audio signal, based on the sound field picked up in the environment of the user, to enable the user to listen to the media content in different environments with greater intelligibility.

In some implementations, the amounts may be determined continuously by the mix adjustor 110 based on spectral differences between the ambient signal and the speech portion of the media content. For example, the amount of the speech audio signal may be increased based on speech band frequency content increasing and/or non-speech band frequency content decreasing in the ambient signal. In another example, the amount of the reference audio signal may be increased based on speech band frequency content decreasing or non-speech band frequency content increasing in the ambient signal. Also, the amounts may be determined based on input from the user, such as a personal volume set by the user. The amounts may each have a variable gain applied by the digital signal processing component, based on loudness of the ambient signal and/or the personal volume, such as a first gain applied via the first digital signal processing component 108A to the speech audio signal, and a second gain applied via the second digital signal processing component 108B to the reference audio signal. This may enable the adaptive playback signal to maintain the personal volume set by the user and maintain the intended level of background sounds in the media content (e.g., artistic intent).

In some implementations, the system 100 may be simplified so that the reference audio signal includes both the speech portion and the non-speech portion of the media content. For example, FIG. 2 illustrates a system 120 for adaptive playback of media content. The system 120 may utilize a media separator 122 to extract the speech audio signal from the media content (e.g., enhanced speech from the media content). Like the media separator 106, the media separator 122 may utilize a machine learning model or other technique to extract the speech audio signal. However, the media separator 122 does not extract the reference audio signal. Instead, while the first digital signal processing component 108A receives the speech audio signal, the second digital signal processing component 108B receives the reference audio signal with both the speech portion and the non-speech portion (e.g., the original audio signal from the media content). The mix adjustor 110 can then adjust amounts of the speech audio signal, via the first digital signal processing component 108A, and the reference audio signal, via the second digital signal processing component 108B, based on the ambient signal and/or the user input, to produce the adaptive playback signal with enhanced speech selectively added to the original signal. This is analogous to adding amounts of enhanced speech back into the original audio signal to produce the adaptive playback signal.

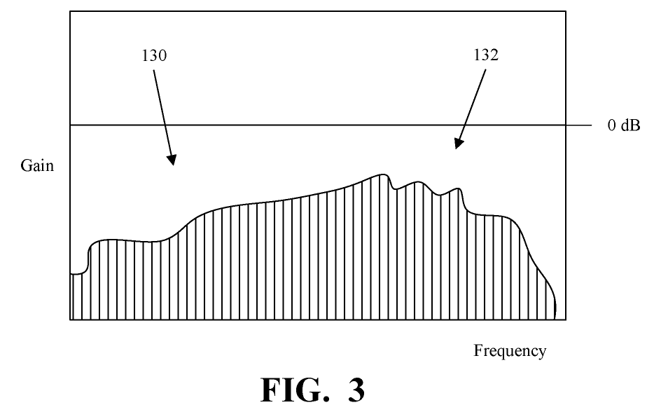

By way of example, FIG. 3 represents a sound field that may be picked up by the microphone 104 at a first time. The first sound field may correspond to an environment with less non-speech band frequency content 130 and more speech band frequency content 132 (e.g., louder speech band frequency content), such as an airport or café with many people talking. The mix adjustor 110 may detect more speech masking of the speech portion of the media content based on the more speech band frequency content 132 indicated by the ambient signal. As a result, the mix adjustor 110 can adjust amounts of the speech audio signal and/or the reference, audio signal with a gain applied, according to compression curves adapted to an environment with less non-speech band frequency content than speech band frequency content, so that the speech audio signal may be emphasized more, and/or the reference audio signal may be emphasized less, while maintaining the personal volume set by the user.

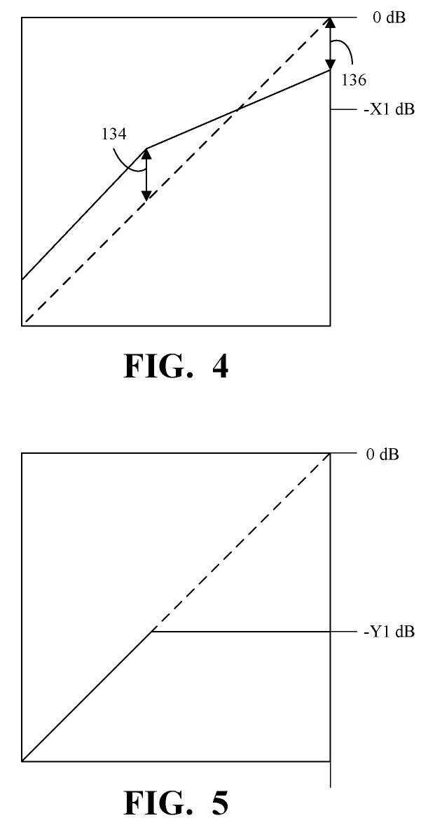

For example, the first digital signal processing component 108A and the second digital signal processing component 108B may each operate as a compressor with automatic gain control. With additional reference to FIG. 4, the mix adjustor 110 can control the first digital signal processing component 108A to adjust the speech audio signal based on a first compression curve for speech (e.g., operating as a voice isolation stream compressor). To adjust the amount of the speech audio signal, the speech audio signal may be increased (boosted) by a variable gain 134 (to a maximum amount) below an enhancement threshold (-X1dB) and decreased (attenuated) by a second variable gain 136 (to another maximum amount) above the enhancement threshold by the mix adjustor 110.

Furthermore, with additional reference to FIG. 5, the mix adjustor 110 can control the second digital signal processing component 108B to adjust the reference audio signal based on a second compression curve for background (e.g., operating as a reference stream compressor). To adjust the amount of the reference audio signal, the reference audio signal may be maintained below a loudness threshold (-Y1dB) (unchanged) and cut off above the loudness threshold by the mix adjustor 110 according to the second compression curve. Thus, masking due to people talking in the environment may cause more emphasis on the speech portion of the media content with more reduction of the non-speech portion of the media content.

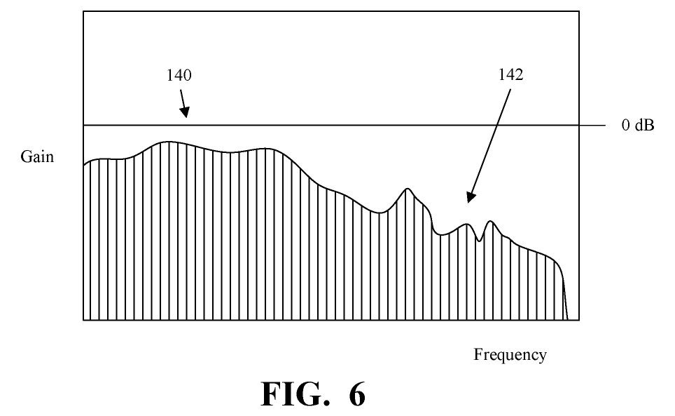

In another example, FIG. 6 represents a sound field that may be picked up by the microphone 104 at a second time. The second sound field may correspond to an environment with more non-speech band frequency content 140 (e.g., louder low frequency content) and less speech band frequency content 142, such as an empty train. The mix adjustor 110 may detect less speech masking of the speech portion of the media content based on the less speech band frequency content 142 in the ambient signal. As a result, the mix adjustor 110 can adjust amounts of the speech audio signal and/or the reference audio signal with a gain applied, according to compression curves adapted to an environment with more non-speech band frequency content than speech band frequency content, so that the speech audio signal may be emphasized less, and/or the reference audio signal may be emphasized more, while maintaining the personal volume set by the user.

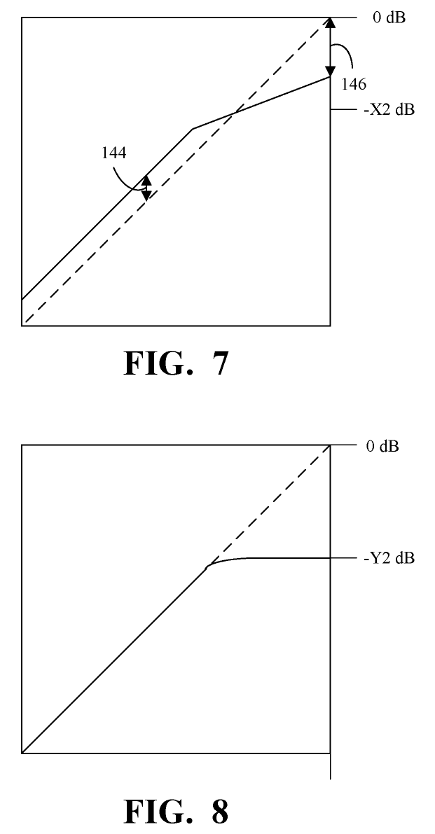

For example, with additional reference to FIG. 7, the mix adjustor 110 can control the first digital signal processing component 108A to adjust the speech audio signal based on a third compression curve for speech (e.g., operating as another voice isolation stream compressor). To adjust the amount of the speech audio signal, the speech audio signal may be increased (boosted) by a variable gain 144 (to a maximum amount, which may be less than the maximum amount of the variable gain 134) below an enhancement threshold (-X2dB) and decreased (attenuated) by a variable gain 146 (to another maximum amount) above the enhancement threshold by the mix adjustor 110.

Furthermore, with additional reference to FIG. 8, the mix adjustor 110 can control the second digital signal processing component 108B to adjust the reference audio signal based on a fourth compression curve for background (e.g., operating as another reference stream compressor). To adjust the amount of the reference audio signal, the reference audio signal may be maintained below a loudness threshold (-Y2dB, which may be greater than -Y1dB) (unchanged) and cut off above the loudness threshold by the mix adjustor 110 according to the fourth compression curve. Thus, in FIG. 6, when the sound field masks the speech portion of the media content less (as compared to FIG. 3), the reference audio signal in FIG. 8 can be louder with less boost of the speech audio signal in FIG. 7, without detracting from intelligibility, while maintaining an intended level of background sounds in the media content.

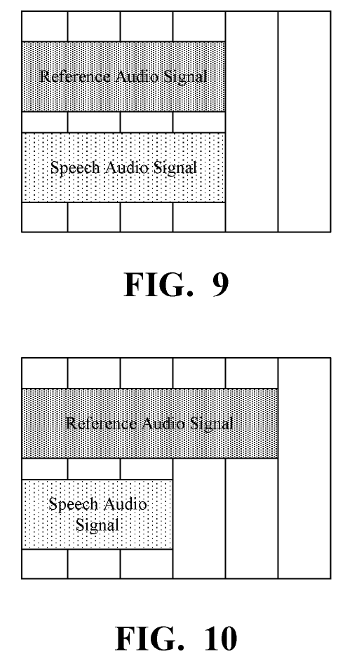

FIG. 9 is an example of mixing a first amount of a speech audio signal with a second amount of a reference audio signal to produce an adaptive playback signal at a first time. For example, the mix adjustor 110 can selectively and variably adjust each of the first digital signal processing component 108A and the second digital signal processing component 108B, independently of one another, based on the ambient signal detecting a first sound field in the environment. The mix adjustor 110 can mix the amounts to produce the adaptive playback signal to drive the speaker 102 based on that detection (e.g., the current spectral frequency content of the environment, such as a background noise level measured in dBA at different frequencies) and its comparison with the media content being played. For example, in FIG. 9, the ambient signal may detect a quiet environment, such as an empty room where less frequency energy and/or speech masking may be detected (e.g., low speech band frequency content in the environment). The amounts may therefore be adjusted by the mix adjustor 110 to be equal. In some cases, the amounts may be equal as a default.

FIG. 10 is an example of mixing a first amount of a speech audio signal with a second amount of a reference audio signal to produce an adaptive playback signal at a second time. Here, the mix adjustor 110 can selectively and variably adjust each of the first digital signal processing component 108A and the second digital signal processing component 108B, independently of one another, based on the ambient signal, this time detecting a second sound field in the environment. The mix adjustor 110 can re-mix the amounts to produce the adaptive playback signal to drive the speaker 102 based on the current detection (e.g., the current spectral frequency content of the environment, such as a background noise level measured in dBA at different frequencies) and its comparison with the current media content being played. For example, the ambient signal may this time detect an environment with more non-speech band frequency content 140 and less speech band frequency content 142 (e.g., louder low frequency content), such as an empty train (e.g., FIG. 6). The amounts may therefore be adjusted from FIG. 9 by the mix adjustor 110 increase the reference audio signal and decrease the speech audio signal.

Reference is now made to flowcharts of examples of processes for audio adjustments for playback of media content. The processes can be executed using computing devices, such as the systems, hardware, and software described with respect to FIGS. 1-10. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

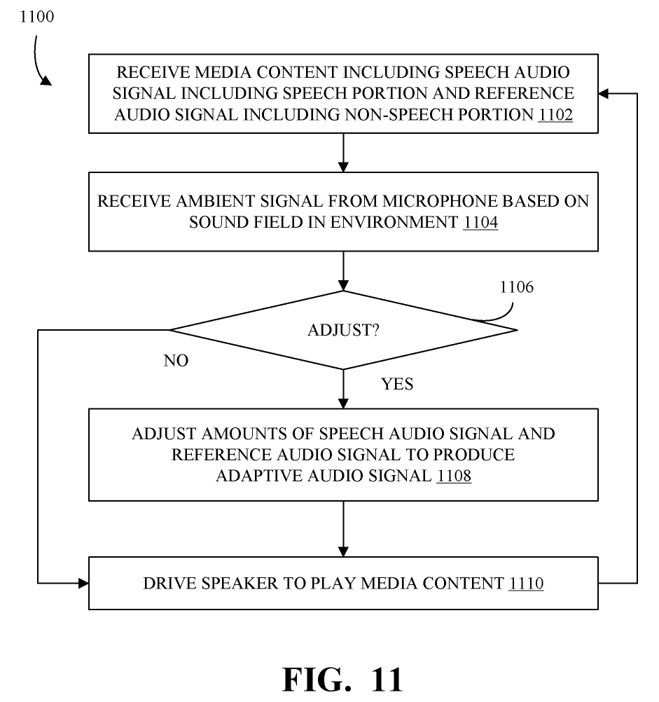

FIG. 11 is an example of a process 1100 for adaptive playback of media content. At operation 1102, a system, such as the system 100 (e.g., a wearable device or headphones worn by a user), may receive a speech audio signal including a speech portion, and a reference audio signal including a non-speech portion, of media content being played by a speaker. For example, the system may be streaming the media content and/or playing the media content from a data storage. In some cases, the system may initially mix default amounts of the speech audio signal and the reference audio signal to produce an adaptive playback signal to drive the speaker. For example, the speech audio signal and the reference audio signal may be mixed equally by default.

At operation 1104, the system may receive an ambient signal from the microphone based on a sound field in an environment of the user. The ambient signal may indicate spectral frequency content in the environment, such as a background noise level measured in dBA at different frequencies. For example, the ambient signal may represent an acoustic sampling of frequency responses in the environment. In some cases, the system may utilize beamforming via a plurality of microphones to pick up a sound field in a select portion of the environment to produce the ambient signal.

At operation 1106, the system, e.g., the mix adjustor 110, may determine whether to adjust amounts of the speech audio signal and/or the reference audio signal based on the ambient signal, such as an amount of speech band frequency content in the ambient signal. The system may determine to adjust the amounts by comparing the spectral frequency content of the environment to the spectral frequency content of the media content being played. For example, the system can compare energy of the speech band frequency content of the environment to energy of the speech portion of the media content. If the system determines speech masking of the media content caused by the environment, at operation 1108 the system can adjust amounts of the speech audio signal to improve intelligibility (and maintain loudness) in producing the adaptive playback signal. However, if at operation 1106 the system does not determine speech masking to be present, the system can bypass operation 1108 to maintain the amounts of the speech audio signal and/or the reference audio signal.

At operation 1110, the system may drive the speaker utilizing the adaptive playback signal. The system may then return to operation 1102 to receive a next portion of the media content and a next acoustic sample of the ambient signal (e.g., frequency response) to further adjust amounts of the speech audio signal and/or the reference audio signal based on the ambient signal.

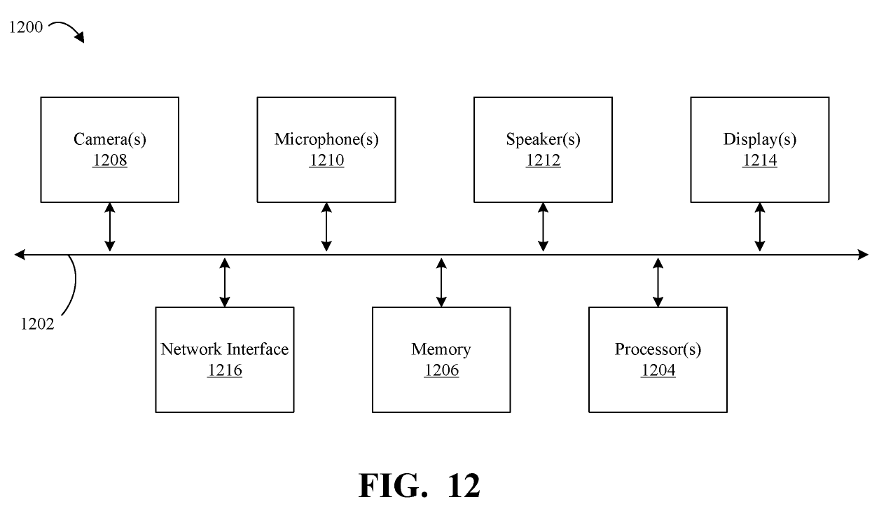

FIG. 12 is an example of hardware of a system which may be used for adaptive playback of media content, such as the system 100 or the system 120. This system can represent a general-purpose computer system or a special purpose computer system. Note that while FIG. 12 illustrates the various components of a system that may be incorporated into one or more of the systems described herein, it is merely one example of a particular implementation and is merely to illustrate the types of components that may be present in the system. FIG. 12 is not intended to represent any particular architecture or manner of interconnecting the components as such details are not germane to the aspects herein. It will also be appreciated that other types of systems that have fewer components than shown or more components than shown in FIG. 12 can also be used. Accordingly, the processes described herein are not limited to use with the hardware and software of FIG. 12.

As shown in FIG. 12, the system 1200 (or device, such as a wearable device, headphones, and/or a companion device) includes one or more buses 1202 that serve to interconnect the various components of the system. One or more processors 1204 are coupled to bus 1202 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 1206 can include Read Only Memory (ROM), volatile memory, and non-volatile memory, or combinations thereof, coupled to the bus using techniques known in the art. Camera(s) 1208, microphone(s) 1210, speaker(s) 1212, and display(s) 1214 may be coupled to the bus 1202.

Memory 1206 can be connected to the bus and can include DRAM, a hard disk drive or a flash memory or a magnetic optical drive or magnetic memory or an optical drive or other types of memory systems that maintain data even after power is removed from the system. In one aspect, the processor 1204 retrieves computer program instructions stored in a machine-readable storage medium (memory) and executes those instructions to perform operations described herein.

Audio hardware, although not shown, can be coupled to one or more buses 1202 in order to receive playback signals to be processed and output (or played back) by speaker(s) 1212. Audio hardware can include digital to analog and/or analog to digital converters. Audio hardware can also include audio amplifiers and filters. The audio hardware can also interface with microphones 1210 (e.g., microphone arrays) to receive playback signals (whether analog or digital), digitize them if necessary, and communicate the signals to the bus 1202.

The network interface 1216 may communicate with one or more remote devices and networks. For example, interface can communicate over known technologies such as Wi-Fi, 3G, 4G, 5G, Bluetooth, ZigBee, or other equivalent technologies. The interface can include wired or wireless transmitters and receivers that can communicate (e.g., receive and transmit data) with networked devices such as servers (e.g., the cloud) and/or other devices such as remote speakers and remote microphones.

The system 1200 may include one or more sensors, detectors, or other devices. For example, the system 1200 can include depth sensor, a geolocation component, such as a global positioning system location unit, a temperature sensor, a gyroscope, etc.

It will be appreciated that some aspects disclosed herein can utilize memory that is remote from the system, such as a network storage device which is coupled to the device through a network interface such as a modem or Ethernet interface. The buses 1202 can be connected to each other through various bridges, controllers, and/or adapters as is well known in the art. In one aspect, one or more network device(s) can be coupled to the bus 1202. The network device(s) can be wired network devices (e.g., Ethernet) or wireless network devices (e.g., WI-FI, Bluetooth). In some aspects, various aspects described (e.g., determination, estimation, analysis, modeling, etc.,) can be performed by a networked server in communication with the capture device.

In one aspect, although illustrated as separate components, one or more components may be a part of (or integrated) together or with an electronic device. For example, the memory 1206 may be a part of one or more processors 1204.

Various aspects described herein may be embodied, at least in part, in software. That is, the techniques may be carried out in an audio system in response to its processor executing a sequence of instructions contained in a storage medium, such as a non-transitory machine-readable storage medium (e.g., DRAM or flash memory). In various aspects, hardwired circuitry may be used in combination with software instructions to implement the techniques described herein. Thus, the techniques are not limited to any specific combination of hardware circuitry and software, or to any particular source for the instructions executed by the device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

An aspect of the disclosure may include a non-transitory machine-readable medium (such as computer memory) having stored thereon instructions, which program one or more data processing components (generically referred to here as a “processor”) to automatically perform operations, as described herein. In other aspects, some of these operations might be performed by specific hardware components that contain hardwired logic. Those operations might alternatively be performed by any combination of programmed data processing components and fixed hardwired circuit components. A “processor” may include a distributed arrangement where multiple processors are configured and controlled to perform the recited operations or tasks together, e.g., one processor can perform some of the recited operations and another processor can perform others of the recited operations.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A system for adaptive playback of media content, comprising:
a speaker to play media content including a speech portion and a non-speech portion;
a microphone to pick up a sound field in an environment of a user; and
a processor configured to:
receive i) a speech audio signal including the speech portion, and ii) a reference audio signal including the non-speech portion;
receive an ambient signal from the microphone based on the sound field; and
adjust amounts of the speech audio signal and the reference audio signal based on the ambient signal to produce an adaptive playback signal to drive the speaker.

2. The system of claim 1, wherein the adaptive playback signal is produced by mixing a first amount of the speech audio signal with a second amount of the reference audio signal.

3. The system of claim 1, wherein including the speech audio signal increases intelligibility of the speech portion and including the reference audio signal maintains a loudness of the media content.

4. The system of claim 1, wherein the amounts of the speech audio signal and the reference audio signal are determined based on spectral differences between the ambient signal and the speech portion.

5. The system of claim 1, wherein the speech audio signal includes only the speech portion, and wherein the reference audio signal includes both the speech portion and the non-speech portion.

6. The system of claim 1, wherein an amount of the speech audio signal is adjusted based on a change in speech band frequency content or non-speech band frequency content in the ambient signal.

7. The system of claim 1, wherein an amount of the reference audio signal is adjusted based on a change in speech band frequency content or non-speech band frequency content in the ambient signal.

8. The system of claim 1, wherein to adjust an amount of the speech audio signal the speech audio signal is increased below a threshold and decreased above the threshold.

9. The system of claim 1, wherein to adjust an amount of the reference audio signal the reference audio signal is maintained below a threshold and cut off above the threshold.

10. The system of claim 1, wherein to adjust the amounts of the speech audio signal and the reference audio signal they each have a gain applied based on loudness of the ambient signal.

11. The system of claim 1, wherein the speech portion includes speech, and wherein the non-speech portion includes music or sound effects.

12. The system of claim 1, wherein the amounts of the speech audio signal and the reference audio signal are determined based on input from the user.

13. The system of claim 1, wherein the amounts of the speech audio signal and the reference audio signal are determined based on a personal volume set by the user.

14. The system of claim 1, wherein the speaker and the microphone are implemented by a wearable device.

15. A method for adaptive playback of media content, comprising:
receiving media content including i) a speech audio signal including a speech portion, and ii) a reference audio signal including a non-speech portion;
receiving an ambient signal from a microphone based on a sound field in an environment of a user picked up by the microphone; and
adjusting amounts of the speech audio signal and the reference audio signal based on the ambient signal to produce an adaptive playback signal to drive a speaker to play the media content.

16. The method of claim 15, wherein including the speech audio signal increases intelligibility of the speech portion and including the reference audio signal maintains a loudness of the media content.

17. The method of claim 15, wherein the amounts of the speech audio signal and the reference audio signal are determined based on spectral differences between the ambient signal and the speech portion.

18. The method of claim 15, further comprising:
adjusting the amounts of the speech audio signal and the reference audio signal based on input from the user.

19. The method of claim 15, wherein an amount of the speech audio signal is adjusted based on a change in speech band frequency content or non-speech band frequency content in the ambient signal.

20. The method of claim 15, wherein an amount of the reference audio signal is adjusted based on a change in speech band frequency content or non-speech band frequency content in the ambient signal.
